(19) United States
(12) Patent Application Publication
(10) Pub. No.: US 2004/0088173 A1
(43) Pub. Date: May 6, 2004

(54) Interactive, certified background check business method

(76) Inventor: Robert Mather, Redding, CA (US)

Correspondence Address: Spohn & Robertson LLP, P.O. Box 5748, Napa, CA, 94581-0748, US

(21) Appl. No.: 10/285,750

(22) Filed: Oct. 31, 2002

(51) Int. Cl. G06F 17/60; H04L 9/00

(52) U.S. Cl. 705/1; 713/200

(57) ABSTRACT

A process and method that provides an individual with the ability to initiate a web page-based, internet background search for information that will be provided to an employer, landlord, or other user of such information. The process accomplishes the search and establishes a data file with verified information that may be accessed by authorized users to verify background information that may be desirable or detrimental in the user's environment. The process allows users to refer candidates to a source that will provide background information in a timely manner and is affordable to most candidates. The candidate has the option of printing out a Certificate from mbc that is a uniquely numbered certification of the background search. Candidate background search information is accessible to employers, landlords, and other users when candidates provide users with certificate number and password.

### FIELD OF THE INVENTION

The present invention is in the field of business processes and pertains in particular to methods for conducting background searches for candidates and certifying the results for potential employers, landlords, and other users using candidate background information for business purposes, including the candidates themselves.

### BACKGROUND OF THE INVENTION

In the field of providing background information for candidates, the burden of time and cost has fallen on employers, landlords, and other users of information and has essentially been unavailable directly to candidates.

Employers, landlords, and other users continually face hurdles in evaluating candidates due to the dynamism of today's economy and the labyrinth of information available and necessary to try to ensure the selection of desirable candidates. The purpose of background checks is an effort to identify candidates who may have a history of violence, dishonesty, or deviant behavior deemed to be detrimental to the employer, landlord, or other user. In an environment of many candidates for an announced employment opportunity the cost and time involved in investigating every candidate presents a considerable burden on the potential employer. The same burden applies to landlords and other potential screeners of candidates. The acquisition process alone may eat up valuable days in the selection of a desirable candidate and may result in the loss of selectivity or availability of available candidates. In addition, the effort involved in the background search expends a considerable amount time and money of the eventual user. Consequently, users address this ET 952745327 US tremendous resource drain in one of two ways: the number of background checks is limited to only very sensitive situations; or background checks are not made at all.

For individuals, few affordable courses of action are available for initiating a background check. One could attempt to have a private investigator check his own background, but lacking knowledge of what types of information an employer, landlord, or other user would likely want requires that the search be broad to be inclusive and therefore makes it enormously expensive

What is clearly needed is a readily available resource wherein an candidate can initiate an affordable background search and provide the results to an employer, landlord, or other user in a certified format. In addition, a system wherein an employer, landlord, or other user could inform potential candidates of the type and depth of data needed for consideration for an opening or situation, would be highly desirable.

What is needed then, is an automated background check system which: provides candidates with an affordable, accessible, and timely method for conducting individual background checks.

In addition, a method of providing candidates with an accessible, single source for accessing the multiplicity of sites containing public record information is needed.

Another need in this field of technology in a business method or process which makes candidates more attractive to employers and increases an candidate's likelihood of being selected by providing certified verification of background information at the time of application to multiple employers, landlords, or other users.

### SUMMARY OF THE INVENTION

In a preferred embodiment of the present information, an interactive web page is maintained that is available to individuals via the Internet. The web page provides the individual candidate with the ability to input personal information, provide credit card information for applicable charges, and establish a password to initiate the data search. In this process the personal data is verified complete and correct and distributed to researchers to accomplish the gathering of desired data pertinent to the candidate's needs. The generated personal and background search data are stored in a database and once verified as complete and correct become available to candidates and users via controlled numbered certificates and candidate provided passwords. In an alterative embodiment of the present invention, candidates may contact the web site provider by mail or FAX to initiate the background check process.

In yet another aspect of the current embodiment of the invention, cost and time associated with background checks are shifted to truly desirable candidates. Employers, landlords, and other users are relieved of the burden of state and federal privacy regulations in collecting personal information. Employers, landlords, and other users are able to direct candidates to the interactive web site with specific recommendations thereby improving the selection time lag and competitiveness of their own selection process. It is a further objective of the preferred embodiment to allow candidates to “tailor” background checks to recommendations set by employers, landlords, and other users.

A fundamental objective of the present invention is to provides candidates with an affordable, accessible, and timely method for conducting individual background checks, as well as to provide candidates with an accessible, single source for accessing the multiplicity of sites containing public record information.

It is yet a further objective of the preferred embodiment to allow candidates to check and review background check information and to correct or remove incorrect information from public record searches.

It is a further objective of the preferred embodiment to provide employers, landlords, and other users with a source for referral for potential candidates for desired background information, to allow businesses to shift the costs associated with background checks to candidates, and to allow businesses to comply with state and federal privacy regulations related to gathering personal information, by the advance consent of dissemination of such data by the candidate.

It is a further objective of the preferred embodiment to reduce the number of requests for criminal background checks; reduce the cost and time of businesses through reduction of conducting individual background checks; and to reduce the time required for businesses to complete the hiring of prospective employees through reduction of time consuming internal or external individual background checks.

It is a further objective of the preferred embodiment to provide an alternative for firms or landlords having the desire to screen candidates but who have no background check budget.

Now, for the first time, a method and process is provided for individuals to initiate a comprehensive, affordable background check to have available when applying for a position, opening, or situation. Additionally, employers, landlords, and other users have a mechanism whereby they can refer potential candidates to a standardized system to timely provide the verified background information desired.

### BRIEF DESCRIPTIONS OF THE DRAWING FIGURES

FIG. 1 is a flow diagram of an exemplary process for initiating a background data search and storing that data in an available database.

FIG. 2 is a flow diagram of an exemplary process for accessing the database for acquiring a Certificate and verification of certified data.

### DESCRIPTION OF THE PREFERRED EMBODIMENTS

According to one embodiment of the present invention, a process is provided for enabling candidates to easily and affordably access a process for initiating their own background search with the specific purpose of obtaining a certified search based on predetermined data and qualifications.

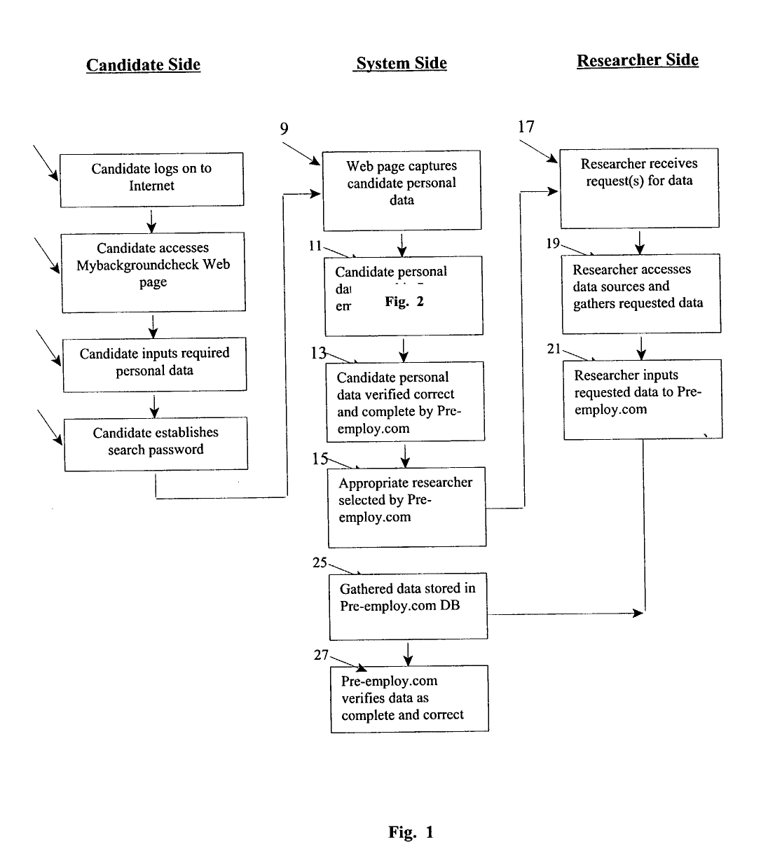

FIG. 1 is a flow diagram illustrating a process according to an embodiment of the present invention wherein a candidate logs on to the Internet 1, accesses a web page 3, inputs required data 5, and establishes a password to initiate a background check 7. Access to the web page may be made by any web-enabled digital device, e.g., cell phone, personal digital assistant, or other device capable of communicating over the Internet.

At the web page, page 3, an applicant is provided with a variety of input fields of data or option selections concerning actions to be taken by a candidate in initiating a background search such as inquiring about the web page provider, viewing a sample certificate, and specified predetermined options and pricing for various types of background searches. In initiating a background search, a candidate is queried, with consent, to supply personal information including, but not limited to, name, social security number, date of birth, address, telephone number, e-mail address, password, and credit card information. Candidate information is entered 5, into the web page data interface in the form and format there defined. A password is selected by the candidate 7, and input into the personal information data input interface and is input a second time to confirm the form and content of the password. On completion of the input activity the candidate is provided with two options by way of menu selection to either register for a background search or reset the data input interface to correct or replace entered information.

Candidate personal data is captured by the interactive web page 9 and is stored in database 11, established and maintained by the web site provider or another entity which has caused the web site to be established.

The web site provider verifies that submitted data 13, used to initiate a background search is correct and complete. The provider then selects appropriate researchers 15, to conduct or complete the search for background information.

Independent contract researchers receive requests for data 17, and continue the search for desired information based on the candidate's inputs. Researchers 19, access various sources of data, and requested background check information is gathered. Researchers input gathered data 21, into the established database for that candidate.

Acquired data is stored 25, in the database in the candidate's data file. The provider verifies the gathered data 27, is complete and correct.

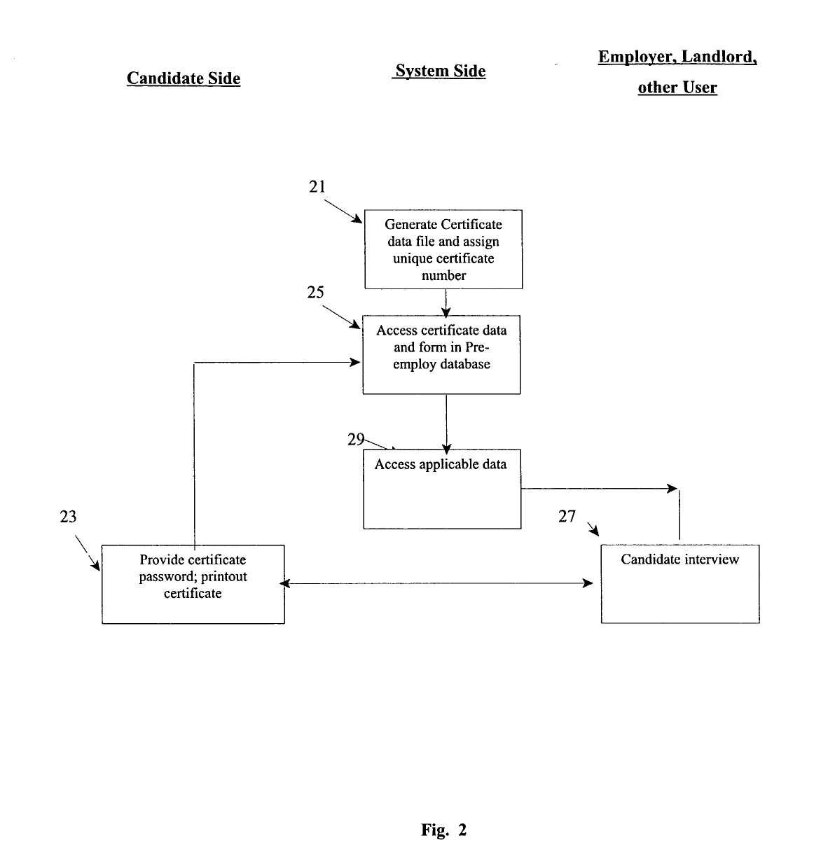

FIG. 2 is a flow diagram illustrating an embodiment of the present invention where the provider generates a file of verified data and allows the printout of a uniquely numbered Certificate authorizing access to appropriate data. A data file is established which contains verified data 21, and a unique certificate number is automatically generated and assigned to the file. When the file is complete and ready, a candidate accesses the file 25, via the web page and provides a new password that allows a Certificate to be printed 23. Candidates then provide the Certificate or access number to an employer, landlord, or other user 27, along with the newly generated password to allow the user to access the candidate's file 29, to confirm the verified background check information.

It will be apparent to one skilled in the art that the process and method presented in the preferred embodiment of the present invention are relatively straightforward and logical and are illustrated in the preferred embodiment. The simple flow diagrams presented herein, however, are sufficient to describe the process and system of the present invention. It will also be apparent to one skilled in the art that the method of the present invention as described in FIG. 1 and FIG. 2 could be applied in various systems or sequences without departing from the spirit and scope of the invention. The present invention as taught hereinabove should be afforded the broadest of scope.

What is claimed is:

1. A business method comprising the steps of:
maintaining an interactive web-site for the purpose of allowing candidates to consensually enter personal data, said data comprising minimally name and social security number, said personal data further generally including address, credit card information, educational experience, and employment history;
providing a database file for maintaining candidate's personal data, said database file being editable by candidate and further being maintainable external to said web-site;
providing a method of secured access to candidate's personal data via said database file, said method of secured access having an identifier or password predetermined by candidate, said identifier or password further being capable of use by third parties made aware of said identifier by candidate;
using said database file as source information for researchers, said researchers obtaining additional information pertaining to said candidate, said web-site having provision for inclusion of said additional information into said database file thereby expanding said database file; and
verification of said expanded database file; and
provision of confirmation of said verification, said confirmation comprising either the downloading of a certificate evidencing such confirmation from said web-site, or the access of said confirmation by said third parties by permission of said candidate.

2. The business method in claim 1 further wherein:
entry of said personal data into said database file may be initialized by the submittal of a written request to the provider of said web-site, said provider then entering said data for expansion and later retrieval by said candidate or said third parties.
